(19) United States
(12) Patent Application Publication
(10) Pub. No.: US 2015/0278440 A1
(43) Pub. Date: Oct. 1, 2015

(54) ANALYZING PROPERTY OF PROTEIN SEQUENCE

(71) Applicant: International Business Machines Corporation, Armonk, NY (US)

(72) Inventors: Jian Dong Ding, SHANGHAI (CN); Zhen Huang, SHANGHAI (CN); Jun Chi Yan, SHANGHAI (CN); Chao Zhang, BEIJING (CN); Ya Nan Zhang, SHANGHAI (CN)

(21) Appl. No.: 14/669,748

(22) Filed: Mar. 26, 2015

(30) Foreign Application Priority Data
Mar. 28, 2014 (CN) 201410123836.0

(51) Int. Cl. G06F 19/22

(52) U.S. Cl. CPC G06F 19/22

(57) ABSTRACT

A method and apparatus for analyzing a property of a protein sequence comprising: looking up in a reference database at least one reference protein sequence that matches the protein sequence in response to having received the protein sequence; mapping the protein sequence and the at least one reference protein sequence to an eigenvector and at least one reference vector respectively by comparing any two sequences in a set comprising the protein sequence and the at least one reference protein sequence; training a classifier by using the at least one reference vector and property of the at least one reference protein sequence; and analyzing property of the protein sequence by the classifier based on the eigenvector. Further an apparatus is provided for analyzing property of a protein sequence. Thus, a property in various respects of the protein sequence can be obtained without manual experiment.

### FIELD

Various embodiments of the present invention relate to data analysis, and more specifically, to a method and apparatus for analyzing property of a protein sequence.

### BACKGROUND

With the development of human society, the studies on biology have gone increasingly deeper. For example, the studies on protein have reached the level of protein sequences. For example, it is now possible to measure a protein sequence and the structure of a protein sequence, and it is now also possible to analyze property of a protein sequence by technical means such as experiment.

A protein sequence may have various respects of property, such as physical property, chemical property, and pathological property, etc. Generally speaking, different experiments have to be designed for determining these respects of property. However, the experiment process is time-consuming and arduous, which heavily relies on manual operation of testers and thus needs huge manpower, material resources and time overheads. In addition, when there is a need to obtain various respects of property of multiple protein sequences, the number of experiments to be conducted will multiply. Therefore, currently it becomes a study focus regarding how to obtain various respects of property of a protein sequence at a lower cost of manpower, material resources and time.

### SUMMARY

Therefore, it is desired to develop a technical solution capable of accurately and efficiently analyzing various respects of property of a protein sequence, and it is desired the technical solution can obtain property of an unknown protein sequence, such as physical property, chemical property, pathological property, etc., based on structures and property of reference protein sequences in a reference database without manual experiment. Further, it is desired to constantly enrich samples of reference protein sequences in the reference database without manual experiment.

According to one aspect of the present invention, there is provided a method for analyzing property of a protein sequence, comprising: looking up in a reference database at least one reference protein sequence that matches the protein sequence in response to having received the protein sequence; mapping the protein sequence and the at least one reference protein sequence to an eigenvector and at least one reference vector respectively by comparing any two sequences in a set comprising the protein sequence and the at least one reference protein sequence; training a classifier by using the at least one reference vector and property of the at least one reference protein sequence; and analyzing property of the protein sequence by the classifier based on the eigenvector.

According to another aspect of the present invention, the looking up in a reference database at least one reference protein sequence that matches the protein sequence in response to having received the protein sequence comprises: looking up in the reference database the at least one reference protein sequence that approximates to text content of the protein sequence.

According to one aspect of the present invention, the mapping the protein sequence and the at least one reference protein sequence to an eigenvector and at least one reference vector respectively by comparing any two sequences in a set comprising the protein sequence and the at least one reference protein sequence comprises: comparing the any two sequences so as to construct a difference matrix, wherein each element in the difference matrix is a set describing difference between the any two sequences; and obtaining the eigenvector and the at least one reference vector based on multiple columns in the difference matrix.

According to one aspect of the present invention, there is provided an apparatus for analyzing property of a protein sequence, comprising: a lookup module configured to, in response to having received the protein sequence, look up in a reference database at least one reference protein sequence that matches the protein sequence; a mapping module configured to map the protein sequence and the at least one reference protein sequence to an eigenvector and at least one reference vector respectively by comparing any two sequences in a set comprising the protein sequence and the at least one reference protein sequence; a training module configured to train a classifier by using the at least one reference vector and property of the at least one reference protein sequence; and an analyzing module configured to analyze property of the protein sequence by the classifier based on the eigenvector.

According to another aspect of the present invention, the lookup module comprises: a similarity lookup module configured to look up in the reference database the at least one reference protein sequence that approximates to text content of the protein sequence.

According to one aspect of the present invention, the mapping module comprises: a constructing module configured to compare the any two sequences so as to construct a difference matrix, wherein each element in the difference matrix is a set describing difference between the any two sequences; and an obtaining module configured to obtain the eigenvector and the at least one reference vector based on multiple columns in the difference matrix.

By means of the method and apparatus of the present invention, property in multiple respects of a protein sequence can be analyzed more rapidly and accurately without manual experiment, and contents in a reference database can be enriched constantly so as to provide a basis for future analysis.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 schematically shows an exemplary computer system/server 12 which is applicable to implement the embodiments of the present invention;

FIG. 2 schematically shows a schematic view of a relationship between a protein sequence and property of the protein sequence;

FIG. 3 schematically shows an architecture diagram of a method for analyzing property of a protein sequence according to one embodiment of the present invention;

FIG. 4 schematically shows a flowchart of a method for analyzing property of a protein sequence according to one embodiment of the present invention;

FIGS. 5A and 5B schematically show respective schematic views of dividing a protein sequence and a reference protein sequence into segments according to one embodiment of the present invention;

FIG. 6 schematically shows a schematic view of the process of mapping a protein sequence to an eigenvector according to one embodiment of the present invention; and

FIG. 7 schematically shows a block diagram of an apparatus for analyzing property of a protein sequence according to one embodiment of the present invention.

### DETAILED DESCRIPTION

Some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

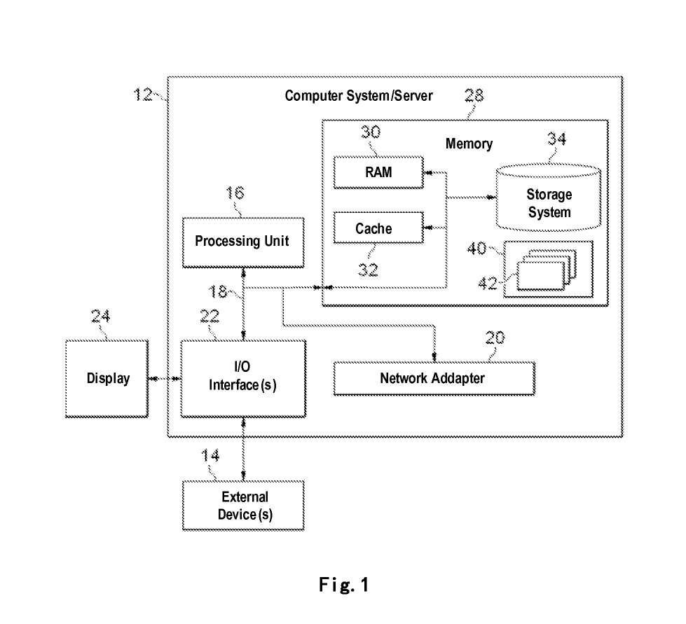

Referring now to FIG. 1, in which an exemplary computer system/server 12 which is applicable to implement the embodiments of the present invention is shown. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

Note a protein sequence includes contents in data and structure respects. The data respect refers to different types of amino acids forming the protein sequence and ordinal relations among these amino acids; on the other hand, the structure respect of the protein sequence refers to that amino acids forming the protein sequence may have different structures (e.g., folded, helical and other stereo structures). Therefore, contents in data and structure respects of the protein sequence have influence on the protein sequence.

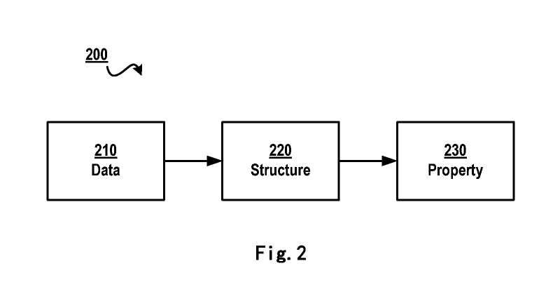

FIG. 2 depicts a schematic view 200 of a relationship between a protein sequence and property of the protein sequence. Under the fundamental principle of biology, data 210 in the protein sequence (i.e., amino acids forming the protein sequence) determines a structure 220 of the protein sequence, and in turn structure 200 determines property 330 of the protein sequence. Various embodiments of the present invention analyze property of the protein sequence based on the dependencies shown in FIG. 2. Specifically, in one embodiment of the present invention, when an unknown protein sequence is received, a reference protein sequence matching the unknown protein sequence may be looked up in a reference database, and further property of the unknown protein sequence is analyzed using property of this known reference protein sequence.

Specifically, the present invention provides a method for analyzing property of a protein sequence, comprising: in response to having received the protein sequence, looking up in a reference database at least one reference protein sequence that matches the protein sequence; by comparing any two sequences in a set comprising the protein sequence and the at least one reference protein sequence, mapping the protein sequence and the at least one reference protein sequence to an eigenvector and at least one reference vector, respectively; using the at least one reference vector and property of the at least one reference protein sequence to train a classifier; and analyzing property of the protein sequence by the classifier based on the eigenvector.

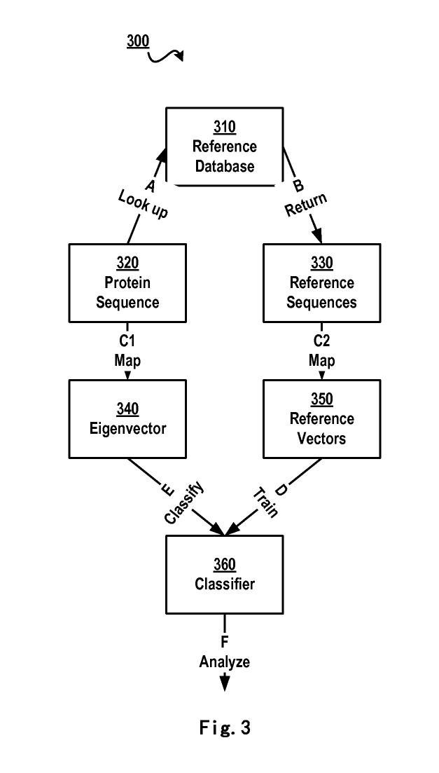

FIG. 3 schematically depicts an architecture diagram 300 of a method for analyzing property of a protein sequence according to one embodiment of the present invention. As shown in FIG. 3, a reference database 310 may store information of known reference protein sequences, e.g., may include data, structure and property of protein sequences; or reference database 310 may only include data structure, but property of protein sequences is stored in other database. When receiving a protein sequence 320, as shown by arrow A, reference protein sequence(s) matching protein sequence 320 may be looked up in reference database 310, and in a step as shown by arrow B reference protein sequence(s) 330 is returned (in the context of the present invention, one or more reference protein sequences 330 might be returned based on different matching algorithms).

A general-purpose data format has been defined with respect to data and structure of protein sequences, and nowadays there exist a great many protein sequence databases, free or paid. In one embodiment of the present invention, these existing protein sequence databases (e.g., SWISSPORT, the world's most renowned protein sequence database) may be directly used and serve as reference database 310 in the context of the present invention.

Subsequently, protein sequence 320 may be compared with reference sequences 330, and protein sequence 320 and reference sequences 330 are mapped to an eigenvector 340 (as shown by arrow C1) and reference vectors 350 (as shown by arrow C2), respectively. Note reference sequences and reference vectors are in a one-to-one correspondence relationship, i.e., one reference sequence corresponds to one reference vector. Then, a classifier 360 may be trained using reference vectors 350 (as shown by arrow D), and eigenvector 340 is classified using classifier 360 in a subsequent step (as shown by arrow E) for analyzing property of protein sequence 320 (as shown by arrow F).

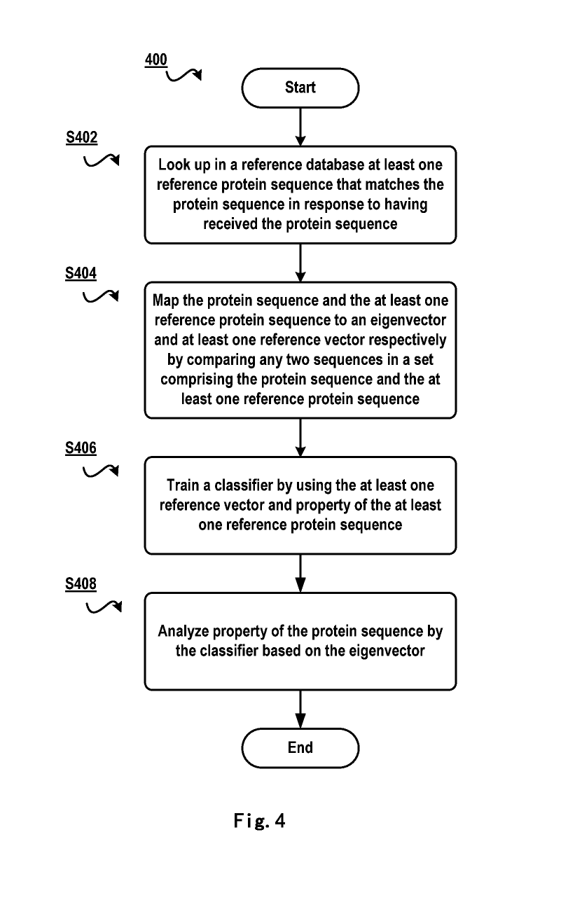

With reference to FIGS. 4-7 below, detailed description is presented to various embodiments of the present invention. FIG. 4 schematically depicts a flowchart 400 of a method for analyzing property of a protein sequence according to one embodiment of the present invention. First of all, in step S402 in response to having received a protein sequence, at least one reference protein sequence matching the protein sequence is looked up in a reference database. In this step, the received protein sequence is a protein sequence whose property is to be analyzed. As described above, various embodiments of the present invention may analyze property of a protein sequence based on dependencies between data, structure and property of the protein sequence. Therefore, reference protein sequences matching the protein sequence need to be looked up first in this step.

Those skilled in the art should note since structure of the protein sequence determines property, if a reference protein sequence matching structure of the protein sequence is found in the reference database directly, then property of the reference protein sequence may be directly used as property of the protein sequence.

In step S404, by comparing any two sequences in a set comprising the protein sequence and the at least one reference protein sequence, the protein sequence and the at least one reference protein sequence are mapped to an eigenvector and at least one reference vector respectively. In this embodiment, the protein sequence may be mapped to an eigenvector, and each reference protein sequence may be mapped to a corresponding reference vector.

Specifically, eigenvalues of various protein sequences (including the received protein sequence and the reference protein sequences) may be extracted by mathematical calculation. Here, the eigenvalue may represent an identifier that is extracted from a protein sequence and that can identify data and structure of the protein sequence. Specifically, the eigenvalue may be represented in form of a vector. Concerning the protein sequence and the reference protein sequences, their corresponding eigenvalues are referred to as an eigenvector and reference vectors. For the purpose of clarity, the eigenvalue of the received protein sequence may be represented as an eigenvector, and eigenvalues of the reference protein sequences may be represented as reference vectors.

In step S406, a classifier is trained using the at least one reference vector and property of the at least one reference protein sequence. After obtaining the reference vectors, they may be used to train a classifier. Specifically, the present invention is not intended to limit concrete examples of a classifier that can be used, but those skilled in the art may use various classifiers that are known in the prior art and/or to be developed in future. In addition, those skilled in the art may understand the classifier may classify various respects of the protein sequence. For example, the classifying may be conducted with respect to hydrophilic and hydrophobic respects of the protein sequence, or the classifying may be conducted with respect to other property of the protein sequence. Therefore, the trained classifier may include a plurality of known categories.

Finally in step S408, the classifier analyzes property of the protein sequence based on the eigenvector. Since the resultant classifier in step S406 has learned the correspondence relationship between the reference vectors and the reference protein sequences, when inputting the eigenvector into the classifier, the category of property of the to-be-analyzed protein sequence can be obtained, and further property of the to-be-analyzed protein sequence can be obtained.

According to the embodiment as shown in FIG. 4, property of the to-be-analyzed protein sequence can be obtained through calculation without manual experiment. Thereby, where there are sufficient reference protein sequences in the reference database, various respects of property of the to-be-analyzed protein sequence can be obtained through one-time calculation. Further, by means of the technical solution of the present invention, multiple protein sequences may be analyzed, at this point the time overhead for analysis is only the time overhead of various processing steps in the process as shown in FIG. 4. Compared with a traditional experimental method costing a couple of or even more days, the technical solution of the present invention increases time efficiency greatly and reduces the overhead in manpower and material resources.

In one embodiment of the present invention, the looking up in a reference database at least one reference protein sequence that matches the protein sequence in response to having received the protein sequence comprises: looking up in the reference database the at least one reference protein sequence that approximates to text content of the protein sequence.

Since a data format of protein sequences has been defined, reference protein sequences matching the received protein sequence may be looked up based on the definition of the existing data format. Specifically, text data of the protein sequence and various protein sequences in the reference database may be obtained, and further reference protein sequences are looked up by text comparison. Specifically, the comparison may be made based on an n-gram and using a sliding window. Since a protein sequence is a quite long sequence made up of amino acids, making analysis by means of an n-gram in the probabilistic language model can enhance the data processing efficiency significantly. For more details of the n-gram, reference may be made to http://en.wikipedia.org/wiki/N-gram, which will not be detailed in the context of the present invention. Or those skilled in the art may further use a text comparison approach that is currently known and/or to be developed in future, to extract from the reference database one or more reference protein sequences that match the inputted protein sequence.

In one embodiment of the present invention, the at least one reference protein sequence includes two or more reference protein sequences, wherein the mapping the protein sequence and the at least one reference protein sequence to an eigenvector and at least one reference vector respectively by comparing any two sequences in a set comprising the protein sequence and the at least one reference protein sequence comprises: comparing the protein sequence with any one in the at least one reference protein sequence so as to map the protein sequence to the eigenvector; and with respect to a current reference protein sequence in the at least one reference protein sequence, comparing the current reference protein sequence with each reference protein sequence other than the current reference protein sequence in the at least one reference protein sequence and the protein sequence, so as to map the current reference protein sequence to a corresponding reference vector.

Detailed description is presented below to how to obtain the eigenvector and the reference vectors. For the purpose of convenience, suppose n−1 reference protein sequences (denoted as P₁, . . . , Pᵢ, . . . , Pₙ₋₁) are obtained from the reference database, and the inputted protein sequence is denoted as Pₙ. The inputted protein sequence Pₙ may be compared with each of the n−1 reference protein sequences so as to obtain the eigenvector. On the other hand, to obtain a reference vector corresponding to a given reference protein sequence (e.g., P₁), the reference protein sequence P₁ may be compared with P₂, . . . , Pᵢ, . . . , Pₙ₋₁, and Pₙ respectively, so as to obtain a reference vector corresponding to P₁.

In one embodiment of the present invention, the mapping the protein sequence and the at least one reference protein sequence to an eigenvector and at least one reference vector respectively by comparing any two sequences in a set comprising the protein sequence and the at least one reference protein sequence comprises: comparing the any two sequences so as to construct a difference matrix, wherein each element in the difference matrix is a set describing difference between the any two sequences; and obtaining the eigenvector and the at least one reference vector based on multiple columns in the difference matrix.

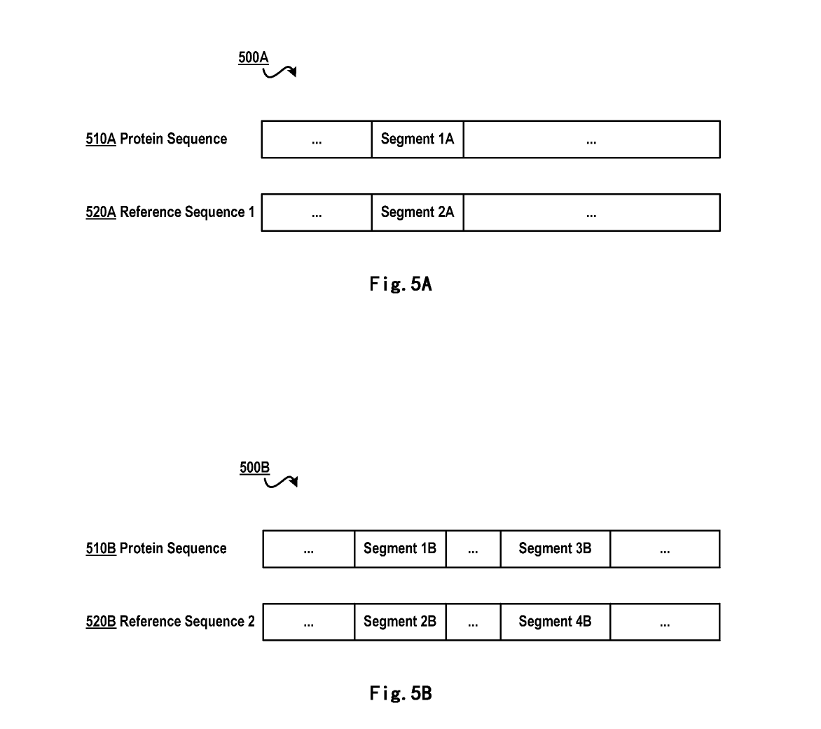

To compare two sequences and obtain the difference therebetween, each sequence may be divided into segments so as to identify segments with difference between the two sequences. Specifically, FIGS. 5A and 5B schematically depict a schematic view 500A and a schematic view 500B of dividing a protein sequence and a reference protein sequence into segments according to one embodiment of the present invention, respectively. As shown in FIG. 5A, there are shown resultant segments when comparing difference between a protein sequence 510A and a reference sequence 1 520A. Suppose at this point a difference exists between a segment 1A in protein sequence 510A and a segment 2A in reference sequence 1 520A, then locations of segment 1A and segment 2A may be recorded for subsequent calculation. In the context of the present invention, the difference refers to text difference.

Those skilled in the art should understand when comparing difference between different sequences, division may be conducted in different ways. As shown in FIG. 2, there are shown resultant segments when comparing text similarity between a protein sequence 510B and a reference sequence 2 520B. Suppose at this point there is difference between a segment 1B in protein sequence 510B and a segment 2B in a reference sequence 2 520B, and there is difference between a segment 3B in protein sequence 510B and a segment 4B in a reference sequence 2 520B. So locations of segment 1B and segment 2B as well as locations of segment 3B and segment 4B may be recorded for subsequent calculation.

Detailed description is presented below to how to construct a difference matrix. The difference matrix may be represented by Equation 1 below:

$$Matrix = [ \begin{matrix}Null & difset ( {P}_{2} , {P}_{1} ) & difset ( {P}_{3} , {P}_{1} ) & … & difset ( {P}_{n} , {P}_{1} ) \\ difset ( {P}_{1} , {P}_{2} ) & Null & difset ( {P}_{3} , {P}_{2} ) & … & difset ( {P}_{n} , {P}_{2} ) \\ difset ( {P}_{1} , {P}_{3} ) & difset ( {P}_{2} , {P}_{3} ) & Null & … & difset ( {P}_{n} , {P}_{3} ) \\ … & … & … & Null & … \\ difset ( {P}_{1} , {P}_{n} ) & difset ( {P}_{2} , {P}_{n} ) & difset ( {P}_{3} , {P}_{n} ) & … & Null\end{matrix} ] \qquad Equation 1$$

Each element difset(Pᵢ, Pⱼ) in the difference matrix shown in Equation 1 represents a set of differences between any two sequences Pᵢ and pⱼ. Specifically, suppose with respect to two sequences shown in FIG. 5A, difference exists only between segment 1A and segment 2A, then a difference set difset(Pₙ, P₁) between a protein sequence Pₙ and a reference protein sequence P₁ includes only one member (i.e., segment 1A, segment 2A and corresponding structure difference). For another example, with respect to two sequences shown in FIG. 5B, a difference set difset(Pₙ, P₂) between protein sequence Pₙ and reference protein sequence P₂ will include two members.

In one embodiment of the present invention, the comparing the any two sequences so as to construct a difference matrix comprises: with respect to the any two sequences, identifying at least one pair of text difference segments in the any two sequences; with respect to current text difference segments in the at least one pair of text difference segments, comparing protein structures of the current text difference segments; and in response to the protein structures differing, adding identifiers of the current text difference segments and corresponding difference of the protein structures to elements associated with the any two sequences.

Continue the example shown in FIGS. 5A and 5B. In FIG. 5A, segment 1A and segment 2A are one pair of text difference segments, while in FIG. 5B segment 1B and segment 2B are one pair of text difference segments, and segment 3B and segment 4B are one pair of text difference segments. Take the two pairs of text difference segments in FIG. 5B as an example only. Difference between a structure of segment 1B and a structure of segment 2B needs to be looked up in the reference database, and the difference is recorded as D1; further, difference between a structure of segment 3B and a structure of segment 4B needs to be looked up in the reference database, and the difference is recorded as D2. When multiple pairs of text difference segments exist between the two sequences, further processing needs to be performed with respect to each pair of text difference segments.

Note since property of protein relies on a structure, in the context of the present invention, only pairs of text difference segments with different structures are added to the difference set, but pairs of text difference segments with the same structure are not added to the difference set. In other words, when two text difference segments have the same structure, it is considered that the text difference is not so significant as to prejudice the performance of protein sequences.

In one embodiment of the present invention, each element difset(Pᵢ, Pⱼ) in the difference matrix may be represented by an equation below:

difset(Pᵢ,Pⱼ)=(dif(pᵢ_{₁}_{,j}_{₁},pᵢ_{₁}_{,j}_{₁}′,Dᵢ_{₁}_{,j}_{₁}),dif(pᵢ_{₂}_{,j}_{₂},pᵢ_{₂}_{,j}_{₂}′,Dᵢ_{₂}_{,j}_{₂}) . . . ) Equation 2

Wherein pᵢ_{₁}ⱼ_{₁} represents an identifier of a segment in sequence Pᵢ, p₁_{₁}_{,j}_{₁}′ represents an identifier of a segment in sequence Pⱼ, and Dᵢ_{₁}_{,j}_{₁} represents difference between structures of these two segments. Based on Equation 1 and Equation 2 described above, those skilled in the art may construct the difference matrix.

In one embodiment of the present invention, there is further comprised: predicting the protein structure in response to there existing in the reference database no protein structure of any of the any two sequences in the set. Note there have been developed methods for predicting a structure of a protein sequence. Thereby, when a structure of a given protein sequence cannot be obtained from the reference database, existing methods may be used for predicting the structure of the protein sequence. The embodiments of the present invention are not intended to limit a concrete method for predicting a structure of protein. Those skilled in the art may select an appropriate method based on concrete application environment, which is not detailed here.

Detailed description is presented below to how to obtain an eigenvector and reference vectors based on a difference matrix. In one embodiment, the obtaining the eigenvector and the at least one reference vector based on multiple columns in the difference matrix comprises: with respect to one column among the multiple columns, calculating values corresponding to respective elements in the column based on a mutual information function; and combining the values from the respective elements to form any one of the at least one reference vector and the eigenvector.

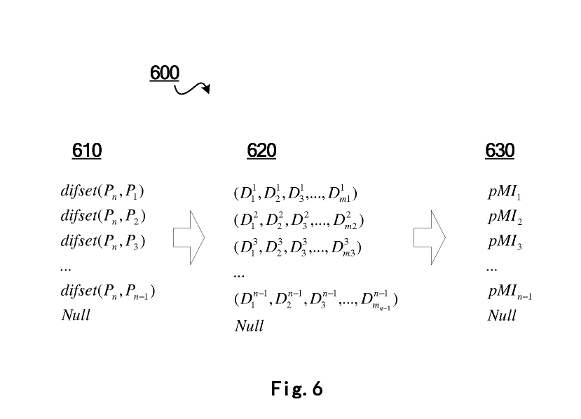

In one embodiment of the present invention, the matrix shown in Equation 1 above may be divided into n columns, and a corresponding vector is obtained from each column Specifically, a reference vector 1 for reference protein sequence P₁ may be obtained from the first column, a reference vector 2 for reference protein sequence P₂ may be obtained from the second column, . . . , and an eigenvector for the inputted protein sequence may be obtained from the n^{th} column With reference to FIG. 6, detailed description is presented below in the context of how to obtain an eigenvector of an inputted protein sequence. Those skilled in the art may obtain various reference vectors similarly according to this example.

FIG. 6 schematically depicts a schematic view 600 of the process of mapping a protein sequence to an eigenvector according to one embodiment of the present invention. In FIG. 6, 610 depicts the n^{th} column in a difference matrix obtained according to the above method. As seen from Equation 2, each element in the n^{th} column is a set of differences between an inputted protein sequence and other reference protein sequence. Specifically, the first element difset (Pₙ, P₁) represents a set of differences between inputted protein sequence Pₙ and the first reference protein sequence P₁ As shown in FIG. 6, suppose there are m1 differences between two sequences, then based on Equation 2 the n^{th} column in the difference matrix may be unfolded as a form shown by a column 620.

As shown by 620 in FIG. 6, inputted protein sequence Pₙ has m1 differences from the first reference protein sequence P₁, m2 differences from the second reference protein sequence P₂, . . . , and mₙ₋₁ differences from the n−1^{th} reference protein sequence Pₙ₋₁. An element Dᵥ^{u} in column 620 in FIG. 6 represents the v^{th} difference between inputted protein sequence Pₙ and the u^{th} reference protein sequence. In FIG. 6, differences in Equation 2 are abbreviated as the form as shown by reference numeral 620 by omitting an identifier of a segment.

Next, with respect to each element in column 620 (each element includes a set describing structure differences between two sequences), a value corresponding to each element may be calculated based on a mutual information function.

Mutual information is a measurement of information, for describing correlation between two event sets. In the context of the present invention, it is not intended to limit which function is used for calculation, but those skilled in the art may make reference to various methods that are existing in the prior art and/or to be developed in future. For example, a function as shown in Equation 3 below may be used:

$$pMI ( {s}_{i} ) = \frac{1}{\vert Struc - Neib \vert} {\sum }_{l ∈ struc - Neib} cMI ( l ) = \frac{1}{Struc - {cons}_{neib} ( k )} {\sum }_{l ∈ struc - Neib} {cons}_{JSD} ( k ) {\sum }_{l ∈ struc - Neib} cMI ( l ) \\ Where \text{:} \\ {cons}_{JSD} = \frac{JSD ( k ) - {μ}_{JSD}}{{σ}_{JSD}} , where \\ JSD ( k ) = H ( \frac{{f}_{K}^{obs} - {f}^{backgr}}{2} ) - \frac{1}{2} H ( {f}_{K}^{obs} ) - \frac{1}{2} H ( {f}^{backgr} ) \qquad Equation 3$$

fₖ^{obs} is a probability mass function, approximating to making statistics on amino acid frequency on each column after comparing n protein sequences, wherein k is a segment in a set Si;
f^{backgr} is the same as fₖ^{obs}, for making statistics on amino acid frequency on each column of a sequence in the entire reference database;
H(.) represents Shannon entropy;
consJSD, z-score represents a standard score, which measures sequence specific degree;
   |Struc-Neib| represents a set of neighboring structures of a segment K;
cMI represents a mutual information function between protein's structure and property.

More principles about mutual information will not be detailed in the context of the present invention, and those skilled in the art may make reference to Buslje, C. M. et al. (2010) Networks of high mutual information define the structural proximity of catalytic sites: implications for catalytic residue identification. PLoS comput. Biol., 6, e1000978.

Using the above method, column 620 may be mapped to a column 630, wherein the first value pMI₁ in column 630 is a calculation result of applying a mutual information function to the first set (D₁¹, D₂¹, D₃¹, . . . , Dₘ₁¹) in column 620. Column 630 is an eigenvector of the inputted protein sequence Pₙ. Using the above method, those skilled in the art may further obtain reference vectors of each reference protein sequence, which is not detailed here.

Note a circumstance might further exist, where the difference set is an empty set. At this point it may be considered a result obtained based on mutual information calculation is “0,” so “0” may be set at a corresponding location in a vector during forming the vector subsequently. For example, suppose the first element in column 620 in FIG. 6 is an empty set, then pMI₁=0, and further the generated eigenvector is (0, pMI₂, pMI3, . . . ).

In one embodiment of the present invention, the training a classifier by using the at least one reference vector and property of the at least one reference protein sequence comprises: adjusting parameters associated with the classifier so that with respect to a current reference vector among the at least one reference vector, the classifier will classify a current reference protein sequence corresponding to the current reference vector into a known category corresponding to property of the current reference protein sequence.

According to the principles of the present invention, since property of a reference protein sequence is known, the classifier may be trained based on property of the reference protein sequence and a reference vector obtained from the reference protein sequence, and the trained classifier is made capable of classifying the reference protein sequence into a known category when receiving a reference vector corresponding to the reference protein sequence.

For the purpose of simplicity, suppose a reference vector corresponding to the reference protein sequence P₁ is V₁ and this reference protein sequence is hydrophilic protein, then the classifier, when receiving the input V₁, will classify reference protein sequence P₁ into a hydrophilic protein category. When there exist multiple other reference protein sequences, the classifier may further classify other reference protein sequence into a corresponding known category based on a reference vector of this other reference protein sequence.

In one embodiment of the present invention, the analyzing property of the protein sequence by the classifier based on the eigenvector comprises: classifying the protein sequence into the known category by the classifier based on the eigenvector; and analyzing property of the protein sequence based on the known category.

In this embodiment, since the classifier has knowledge of correlation in reference vector property, when receiving an eigenvector of an unknown protein sequence, the classifier may classify the unknown protein sequence into a corresponding known category. For example, suppose the classifier has received an eigenvector V of a protein sequence Pₙ and classifies the protein sequence Pₙ into a hydrophobic protein category, then it is indicated the protein sequence Pₙ belongs to hydrophobic protein. In this manner, property of a protein sequence can be analyzed without any manual experiment.

In one embodiment of the present invention, there is further comprised: adding the protein sequence and the analyzed property to the reference database. Where property of the protein sequence Pₙ has been analyzed, the protein sequence Pₙ and the corresponding property can be added to the reference database to serve as a basis for future analysis.

Various embodiments implementing the method of the present invention have been described above with reference to the accompanying drawings. Those skilled in the art may understand that the method may be implemented in software, hardware or a combination of software and hardware. Moreover, those skilled in the art may understand by implementing steps in the above method in software, hardware or a combination of software and hardware, there may be provided an apparatus based on the same invention concept. Even if the apparatus has the same hardware structure as a general-purpose processing device, the functionality of software contained therein makes the apparatus manifest distinguishing properties from the general-purpose processing device, thereby forming an apparatus of the various embodiments of the present invention. The apparatus described in the present invention comprises several means or modules, the means or modules configured to execute corresponding steps. Upon reading this specification, those skilled in the art may understand how to write a program for implementing actions performed by these means or modules. Since the apparatus is based on the same invention concept as the method, the same or corresponding implementation details are also applicable to means or modules corresponding to the method. As detailed and complete description has been presented above, the apparatus is not detailed below.

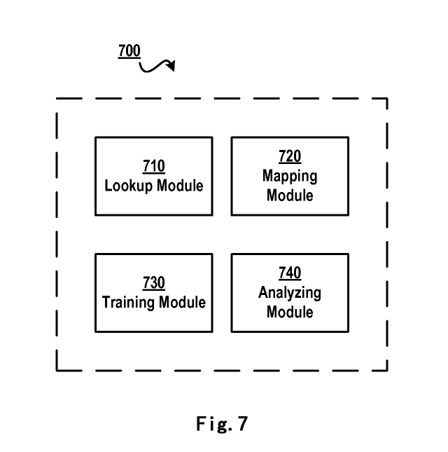

FIG. 7 depicts a block diagram 700 of an apparatus for analyzing property of a protein sequence according to one embodiment of the present invention. Specifically, there is provided an apparatus for analyzing property of a protein sequence, comprising: a lookup module 710 configured to, in response to having received the protein sequence, look up in a reference database at least one reference protein sequence that matches the protein sequence; a mapping module 720 configured to map the protein sequence and the at least one reference protein sequence to an eigenvector and at least one reference vector respectively by comparing any two sequences in a set comprising the protein sequence and the at least one reference protein sequence; a training module 730 configured to train a classifier by using the at least one reference vector and property of the at least one reference protein sequence; and an analyzing module 740 configured to analyze property of the protein sequence by the classifier based on the eigenvector.

In one embodiment of the present invention, lookup module 710 comprises: a similarity lookup module configured to look up in the reference database the at least one reference protein sequence that approximates to text content of the protein sequence.

In one embodiment of the present invention, the at least one reference protein sequence includes two or more reference protein sequences, wherein mapping module 720 comprises: a first mapping module configured to compare the protein sequence with any one in the at least one reference protein sequence so as to map the protein sequence to the eigenvector; and a second mapping module configured to, with respect to a current reference protein sequence in the at least one reference protein sequence, compare the current reference protein sequence with each reference protein sequence other than the current reference protein sequence in the at least one reference protein sequence and the protein sequence, so as to map the current reference protein sequence to a corresponding reference vector.

In one embodiment of the present invention, mapping module 720 comprises: a constructing module configured to compare the any two sequences so as to construct a difference matrix, wherein each element in the difference matrix is a set describing difference between the any two sequences; and an obtaining module configured to obtain the eigenvector and the at least one reference vector based on multiple columns in the difference matrix.

In one embodiment of the present invention, the constructing module comprises: an identifying module configured to, with respect to the any two sequences, identify at least one pair of text difference segments in the any two sequences; a comparing module configured to, with respect to current text difference segments in the at least one pair of text difference segments, compare protein structures of the current text difference segments; and in response to the protein structures differing, add identifiers of the current text difference segments and corresponding difference of the protein structures to elements associated with the any two sequences.

In one embodiment of the present invention, there is further comprised: a structure predicting module configured to predict the protein structure in response to no protein structure of any of the any two sequences in the set existing in the reference database.

In one embodiment, the obtaining module comprises: a calculating module configured to, with respect to one column among the multiple columns, calculate values corresponding to respective elements in the column based on a mutual information function; and a combining module configured to combine the values from the respective elements to form any one of the at least one reference vector and the eigenvector.

In one embodiment of the present invention, training module 730 comprises: an adjusting module configured to adjust parameters associated with the classifier so that with respect to a current reference vector among the at least one reference vector, the classifier classifies a current reference protein sequence corresponding to the current reference vector into a known category corresponding to property of the current reference protein sequence.

In one embodiment of the present invention, analyzing module 740 comprises: a classifying module configured to classify the protein sequence into the known category by the classifier based on the eigenvector; and a property analyzing module configured to analyze property of the protein sequence based on the known category.

In one embodiment of the present invention, there is further comprised: an updating module configured to add the protein sequence and the analyzed property to the reference database.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. (canceled)

2. The method according to claim 21, wherein the looking up in a reference database at least one reference protein sequence that matches the protein sequence in response to having received the protein sequence comprises:
looking up in the reference database the at least one reference protein sequence that approximates to text content of the protein sequence.

3. The method according to claim 21, wherein the at least one reference protein sequence includes two or more reference protein sequences, wherein the mapping the protein sequence and the at least one reference protein sequence to an eigenvector and at least one reference vector respectively by comparing any two sequences in a set comprising the protein sequence and the at least one reference protein sequence comprises:
comparing the protein sequence with any one in the at least one reference protein sequence so as to map the protein sequence to the eigenvector; and
with respect to a current reference protein sequence in the at least one reference protein sequence, comparing the current reference protein sequence with each reference protein sequence other than the current reference protein sequence in the at least one reference protein sequence and the protein sequence, so as to map the current reference protein sequence to a corresponding reference vector.

4. The method according to claim 21, wherein the mapping the protein sequence and the at least one reference protein sequence to an eigenvector and at least one reference vector respectively by comparing any two sequences in a set comprising the protein sequence and the at least one reference protein sequence comprises:
comparing the any two sequences so as to construct a difference matrix, wherein each element in the difference matrix is a set describing difference between the any two sequences; and
obtaining the eigenvector and the at least one reference vector based on multiple columns in the difference matrix.

5. The method according to claim 4, wherein the comparing the any two sequences so as to construct a difference matrix comprises: with respect to the any two sequences,
identifying at least one pair of text difference segments in the any two sequences;
with respect to current text difference segments in the at least one pair of text difference segments,
comparing protein structures of the current text difference segments; and
in response to the protein structures differing, adding identifiers of the current text difference segments and corresponding difference of the protein structures to elements associated with the any two sequences.

6. The method according to claim 5, further comprising:
predicting the protein structure in response to there existing in the reference database no protein structure of any of the any two sequences in the set.

7. The method according to claim 4, wherein the obtaining the eigenvector and the at least one reference vector based on multiple columns in the difference matrix comprises: with respect to one column among the multiple columns,
calculating values corresponding to respective elements in the column based on a mutual information function; and
combining the values from the respective elements to form any one of the at least one reference vector and the eigenvector.

8. The method according to claim 21, wherein the training a classifier by using the at least one reference vector and property of the at least one reference protein sequence comprises:
adjusting parameters associated with the classifier so that with respect to a current reference vector among the at least one reference vector, the classifier classifies a current reference protein sequence corresponding to the current reference vector into a known category corresponding to property of the current reference protein sequence.

9. The method according to claim 8, wherein the analyzing property of the protein sequence by the classifier based on the eigenvector comprises:
classifying the protein sequence into the known category by the classifier based on the eigenvector; and
analyzing property of the protein sequence based on the known category.

10. The method according to claim 21, further comprising:
adding the protein sequence and the analyzed property to the reference database.

11. An apparatus for analyzing property of a protein sequence, comprising:
a lookup module configured to look up in a reference database at least one reference protein sequence that matches the protein sequence in response to having received the protein sequence;
a mapping module configured to map the protein sequence and the at least one reference protein sequence to an eigenvector and at least one reference vector respectively by comparing any two sequences in a set comprising the protein sequence and the at least one reference protein sequence;
a training module configured to train a classifier by using the at least one reference vector and property of the at least one reference protein sequence; and
an analyzing module configured to analyze property of the protein sequence by the classifier based on the eigenvector.

12. The apparatus according to claim 11, wherein the lookup module comprises:
a similarity lookup module configured to look up in the reference database the at least one reference protein sequence that approximates to text content of the protein sequence.

13. The apparatus according to claim 11, wherein the at least one reference protein sequence includes two or more reference protein sequences, wherein the mapping module comprises:
a first mapping module configured to compare the protein sequence with any one in the at least one reference protein sequence so as to map the protein sequence to the eigenvector; and
a second mapping module configured to, with respect to a current reference protein sequence in the at least one reference protein sequence, compare the current reference protein sequence with each reference protein sequence other than the current reference protein sequence in the at least one reference protein sequence and the protein sequence, so as to map the current reference protein sequence to a corresponding reference vector.

14. The apparatus according to claim 11, wherein the mapping module comprises:
a constructing module configured to compare the any two sequences so as to construct a difference matrix, wherein each element in the difference matrix is a set describing difference between the any two sequences; and
an obtaining module configured to obtain the eigenvector and the at least one reference vector based on multiple columns in the difference matrix.

15. The apparatus according to claim 14, wherein the constructing module comprises:
an identifying module configured to, with respect to the any two sequences, identify at least one pair of text difference segments in the any two sequences;
a comparing module configured to, with respect to current text difference segments in the at least one pair of text difference segments, compare protein structures of the current text difference segments; and in response to the protein structures differing, add identifiers of the current text difference segments and corresponding difference of the protein structures to elements associated with the any two sequences.

16. The apparatus according to claim 15, further comprising:
a structure predicting module configured to predict the protein structure in response to there existing in the reference database no protein structure of any of the any two sequences in the set.

17. The apparatus according to claim 14, wherein the obtaining module comprises:
a calculating module configured to, with respect to one column among the multiple columns, calculate values corresponding to respective elements in the column based on a mutual information function; and
a combining module configured to combine the values from the respective elements to form any one of the at least one reference vector and the eigenvector.

18. The apparatus according to any claim 11, wherein the training module comprises:
an adjusting module configured to adjust parameters associated with the classifier so that with respect to a current reference vector among the at least one reference vector, the classifier classifies a current reference protein sequence corresponding to the current reference vector into a known category corresponding to property of the current reference protein sequence.

19. The apparatus according to claim 18, wherein the analyzing module comprises:
a classifying module configured to classify the protein sequence into the known category by the classifier based on the eigenvector; and
a property analyzing module configured to analyze property of the protein sequence based on the known category.

20. The apparatus according to claim 11, further comprising:
an updating module configured to add the protein sequence and the analyzed property to the reference database.

21. A method for analyzing property of a protein sequence, comprising:
looking up in a reference database at least one reference protein sequence that matches the protein sequence in response to having received the protein sequence;
mapping the protein sequence and the at least one reference protein sequence to an eigenvector and at least one reference vector respectively by comparing any two sequences in a set comprising the protein sequence and the at least one reference protein sequence;
training a classifier by using the at least one reference vector and property of the at least one reference protein sequence; and
analyzing property of the protein sequence by the classifier based on the eigenvector.
